(19) United States
(12) Patent Application Publication
(10) Pub. No.: US 2009/0083719 A1
(43) Pub. Date: Mar. 26, 2009

(54) METHOD OF COMPILING MACHINE CODE PROGRAM FOR PROGRAMMABLE LOGIC CONTROLLER

(75) Inventor: Po-Cheng HSIEH, Taoyuan Shien (TW)

Correspondence Address: HDLS Patent & Trademark Services, P.O. BOX 220746, CHANTILLY, VA, 20153-0746, US

(73) Assignee: Delta Electronics, Inc., Taoyuan Hsien (TW)

(21) Appl. No.: 11/858,416

(22) Filed: Sep. 20, 2007

(51) Int. Cl. G06F 9/45

(52) U.S. Cl. 717/140

(57) ABSTRACT

A method of compiling machine code program for programmable logic controller (PLC) reads a PLC program such as a ladder diagram program. The mnemonics codes in the PLC program are searched and checked with syntax correctness regarding PLC logic rule. When all of the mnemonics codes have correct syntax, the PLC program is converted to a C language program and the C language program is then converted into a C language object program. The C language object program is linked with a library file. When the link is successful, the linked program is directly converted into a machine language program for operation of PLC to access external input/output points (EXIO).

### BACKGROUND OF THE INVENTION

1. Field of the Invention

The present invention relates to a method of editing programmable logic controller (PLC) program, especially to a method of compiling machine code program for PLC based on an existing PLC program.

2. Description of Prior Art

The software developed for programmable logic controller (PLC) control program is mainly focused on Ladder Diagram (LD). LD language has simple syntax and is extensively used for PLC control program. However, LD language is lack of high-level language properties such as variable data structure, arithmetic calculation, object orientation design, and program control. Moreover, the syntax of LD language also depends on PLC hardware platform. Therefore, International Electrotechnical Commission (IEC) has defined IEC 61131-3 standard language to incorporate high-level language properties into the program developing tool of PLC control program.

IEC 61131-3 defines the following five standard languages.

1. LD

The programming of LD language requires the information of mechanic operation sequence and control loop should be drawn firstly. Afterward, the contact a and the contact b in relay control, the serial and parallel connection and coil are symbolized.

2. Functional Block Diagram, FBD

FBD is composed of predetermined functional block with suitable connection. Therefore, FBD is especially suitable for data flow in control components.

3. Instructional List (IL) or Statement List (SL)

IL is a low level language composed of Boolean algebra and basic logic operation. IL mainly comprises Mnemonics such as AND, OR and NOT.

4. Structure Text (ST)

ST is for PLC with high level language ability such as arithmetic operation, subroutine, loop and condition judgment. Therefore, the PLC with high level language ability can be linked with PC by communication network.

5. Sequential Function Chart (SFC)

SFC decomposes mechanic operation into sequential function flow and then links the sequential functions to realize integral mechanic operation.

IEC 61131-3 program can be input by program entry device for PLC, or by a computer software in a computer linked to the PLC. The former is suitable for inputting command code; while the latter can input all kinds of PLC languages.

The external Input/output (EXIO) accessed by the HMI and PLC require mnemonic code edited by corresponding software to perform their function, and the mnemonic code needs to be converted into mechanic code. However, the identification and conversion of the mnemonic code cause time delay and the execution speed of PLC program is influenced.

For example, the PLC of Delta electronics (the assignee of this application), the Mitsubishi and other brands provide peculiar screen editor for user. The PLC program is converted to mnemonic code and then the mnemonic code is downloaded to HMI for execution therein. However, the conventional approach has following two disadvantages:

1. All of the mnemonic codes need identification, which is time consuming.

2. All of the variables and the constants need conversion, which influences performance speed.

### SUMMARY OF THE INVENTION

It is an object of the present invention to provide a method of compiling machine code program for PLC based on an existing PLC program, thus enhancing performance speed of PLC.

Accordingly, the present invention provides a method of compiling machine for programmable logic controller (PLC), comprising:

(a). inputting a PLC program;

(b). finding mnemonic codes in the PLC program;

(c). converting the PLC program into a C language program when all of the mnemonic codes have correct PLC logic;

(d). converting the C language program into a C language object program;

(e). linking the C language object program with a library file; and

(f). generating a machine code program corresponding to the C language object program if the C language object program is successfully linked with the library file.

Moreover, when any of the mnemonic codes has incorrect PLC logic in step (c), an error message is prompted.

Moreover, when the linking step is not successful in step (f), an error message is prompted.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows the flowchart of the method for compiling machine code program for PLC according to a preferred embodiment of the present invention.

FIG. 2 shows a schematic view demonstrating the method of producing machine code for PLC.

FIG. 3 shows another schematic view demonstrating the method of producing machine code for PLC.

### DETAILED DESCRIPTION OF THE INVENTION

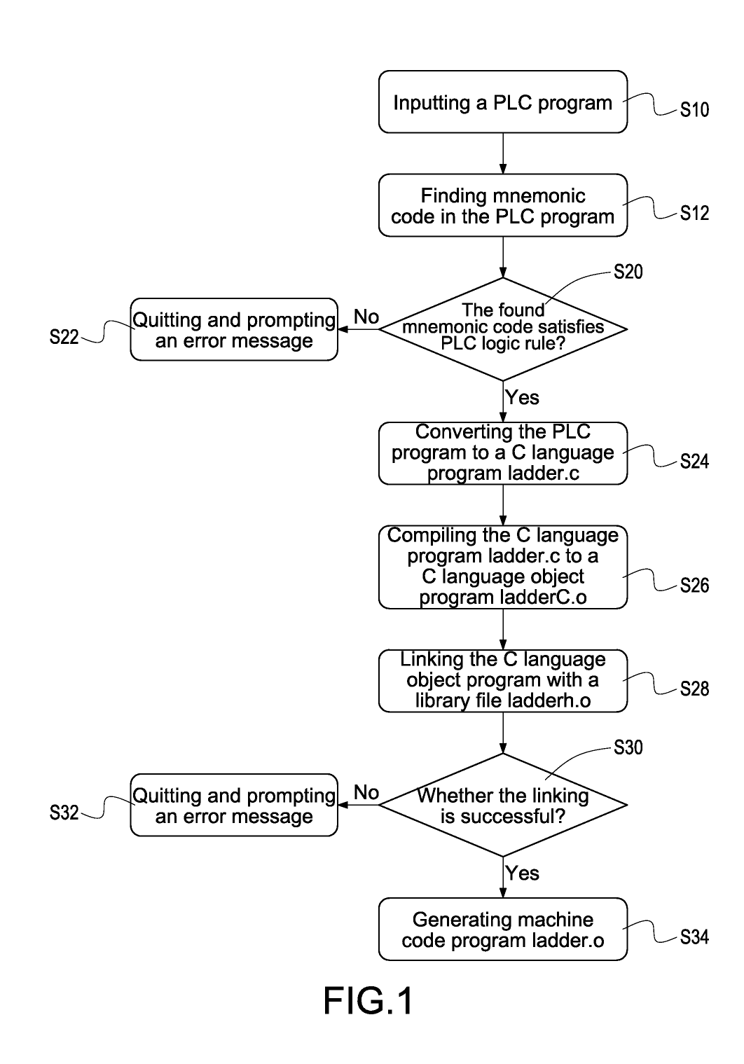

FIG. 1 shows the flowchart of the method for compiling machine code program for PLC according to a preferred embodiment of the present invention. The method of compiling machine code program for PLC according to the present invention can be implemented by computer software and performed by a computer to convert a PLC program to machine code program.

The method of compiling machine code program for PLC according to the present invention comprises following steps.

An already-edited PLC program is opened at step S10, the PLC program, for example, can be a ladder diagram program edited by Delta WPL HMI. The position of mnemonic code is searched in the PLC program in step S12, wherein the mnemonic code can be LD, AND, ANI code. The searched mnemonic code is judged whether it satisfies PLC logic rule in step S20. If any one of the searched mnemonic code does not satisfy PLC logic rule (namely, does not satisfy PLC syntax), the compiling process is quitted and error message with error code is prompted in step S22, whereby user can debug error.

If all of the searched mnemonic codes satisfy PLC logic rule, the PLC program is converted to a C language program ladder.c in step S24. The C language program ladder.c is then compiled by a GCC compilation software in step S26 to generate a C language object code ladderC.o. The C language object code ladderC.o is then linked with a library file ladderh.o in step S28.

The linking process is evaluated whether it is successful in step S30, namely, whether the C language object code ladderC.o is successfully linked with a library file ladderh.o. If not successfully, the compiling process is quitted and error message is prompted in step S32. If successfully, a machine code program ladder.o is generated in step S34.

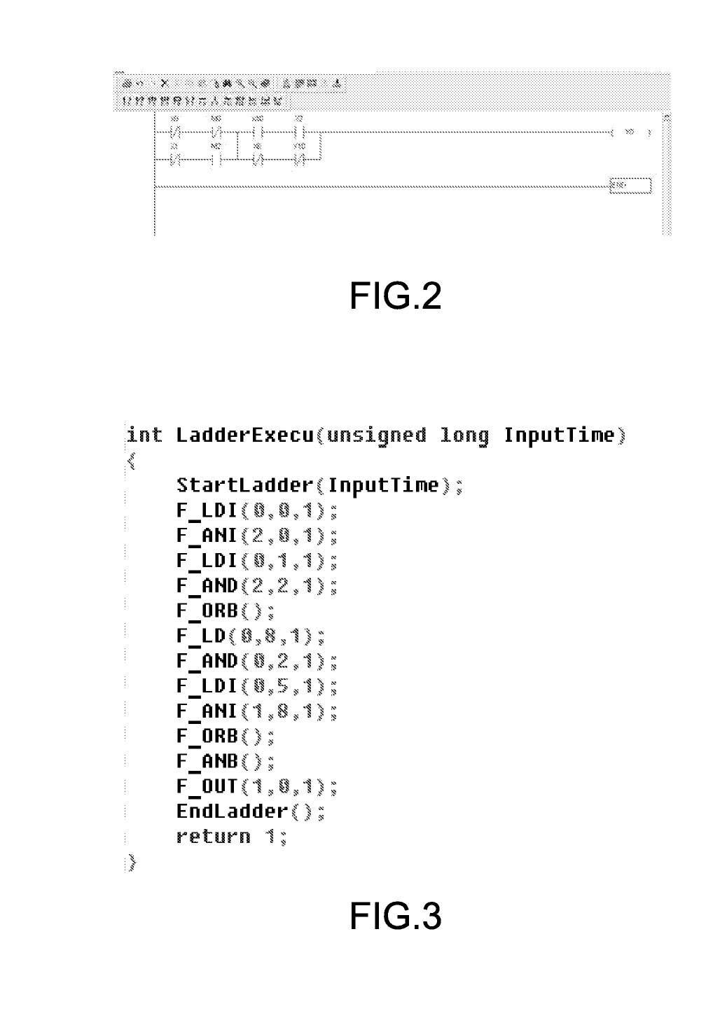

FIG. 2 shows a schematic view demonstrating the method of producing machine code for PLC. FIG. 3 shows another schematic view demonstrating the method of producing machine code for PLC. The PLC program read in step S10 can be the ladder diagram shown in FIG. 2. If all of the mnemonic codes in the ladder diagram program satisfy PLC logic, the input PLC program can be converted to a C language program ladder.c as shown in FIG. 3. A C language program can be easily converted to machine code language by conventional process. Therefore, the C language program ladder.c can be converted to a machine-language counterpart after the C language object code ladderC.o is successfully linked with a library file ladderh.o. The machine-language counterpart can be easily and efficiently performed by a PLC.

As can be seen from above description, an input PLC program is read at HMI end. The input PLC program is compiled into machine code counterpart when there is no PLC logic error (namely, no PLC syntax error) in the input PLC program. More specifically, the input PLC program is converted to a C language program and the C language program (after converted to an object file) is linked with a library file to generate a machine code program. The machine code program can be directly performed by PLC without further identification and conversion task. The program execution efficiency can be enhanced.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A method of compiling machine for programmable logic controller (PLC), comprising:
a). inputting a PLC program;
b). finding mnemonic codes in the PLC program;
c). converting the PLC program into a C language program when all of the mnemonic codes have correct PLC logic;
d). converting the C language program into a C language object program;
e). linking the C language object program with a library file; and
f). generating a machine code program corresponding to the C language object program if the C language object program is successfully linked with the library file.

2. The method in claim 1, further comprising:
prompting an error message when any of the mnemonic codes has incorrect PLC logic in step (c).

3. The method in claim 1, further comprising:
prompting an error message when the linking step is not successful in step (f).

4. The method in claim 1, wherein the machine code program is used to control external input/output points (EXIO) for PLC.

5. The method in claim 1, wherein the PLC program is a ladder diagram program.
